(19) United States
(12) Patent Application Publication
(10) Pub. No.: US 2023/0110110 A1
(43) Pub. Date: Apr. 13, 2023

(54) STARVATION MITIGATION FOR ASSOCIATIVE CACHE DESIGNS

(71) Applicant: Intel Corporation, Santa Clara, CA (US)

(72) Inventor: Patrick NDOUNIAMA, Portland, OR (US)

(21) Appl. No.: 18/073,341

(22) Filed: Dec. 1, 2022

(51) Int. Cl. G06F 12/128; G06F 12/0831

(52) U.S. Cl. CPC G06F 12/128; G06F 12/0835

(57) ABSTRACT

Methods and apparatus for starvation mitigation for associative cache designs. A memory controller employs an associative cache to cache physical page addresses and logic to monitor a level of cache contention. When the contention reaches a critical level where QoS can’t be guaranteed, a backpressure mechanism is triggered by cache contention mitigation logic to prevent new memory access commands from a host from entering a command pipeline. The mitigation logic maintains the backpressure until the monitoring logic indicates that the contention has resolved. The levels of contention that triggers and releases the backpressure may be set using configurable control registers. A starvation counter is incremented when a cache slot cannot be allocated for a command and decremented when a replayed command is allocated a slot. A starvation count is evaluated to determine when backpressure should be triggered and released.

### BACKGROUND INFORMATION

Some memory controllers use a set associative cache to store the logical to physical address translation used to access memory media. Under one example, the set associative cache is organized in 256 sets and 16 ways. The targeted set within the cache is determined by using 8 bits of the logical address of the requesting command.

A Host command requires a valid address translation from the cache before it is allowed to access the memory media. For performance reasons, the memory controller supports a large number of credits for host transactions. Given the cache organization, it is possible for a malicious workload to repeatedly target the same set within the cache which can result in severe contention on the cache resources. In the worst possible scenario, all the host transactions and internal media management commands can target the same set and compete for the 16 slots within that set. The cache contention can result in various undesirable scenarios that need to be mitigated, including:
Indeterministic/Poor QoS (Quality of Service) for media management commands which can result in media failures.
Indeterministic/Poor QoS for Host commands which can result in platform level timeout. In severe contention scenarios commands are not guaranteed forward progress and can remain starved for an indeterministic amount of time.
Indeterministic/Poor QoS for firmware commands which can result in fatal events.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of an example system including a memory controller having an associative cache and cache contention mitigation logic, according to one embodiment;

FIG. 2 is a schematic diagram illustrating further details of the cache contention mitigation logic, according to one embodiment;

FIG. 3 is a flowchart illustrating operations and logic performed by the cache contention mitigation logic, cache controller, and associative cache when operating in a normal mode without backpressure;

FIG. 4 is flowchart illustrating operations and logic performed by the cache contention mitigation logic, cache controller, and associative cache when backpressure is applied;

FIG. 5a is a diagram illustrating a first state of a set associative cache under which a cache lookup results in a HIT;

FIG. 5b is a diagram illustrating a second state of the set associative under which a cache lookup results in a MISS where a slot is available and allocated with a physical page address to service a memory access request;

FIG. 5c is a diagram illustrating a third state of the set associative cache under which all slots for the mapped set have pending fills, resulting in a status of No Slot being returned for a memory access request; and

FIG. 6 is a block diagram of a computer system in which aspects of the embodiments disclosed herein may be implemented.

### DETAILED DESCRIPTION

Embodiments of methods and apparatus for starvation mitigation for associative cache designs are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

Under aspects of the embodiments of the solutions disclosed herein, hardware resources are used to monitor the level of cache contention. When the contention reaches a level where QoS can’t be guaranteed, a backpressure mechanism is triggered to prevent new commands from entering the pipeline. The mitigation logic maintains the backpressure until the monitoring logic indicates that the contention has resolved. The levels of contention that triggers and releases the backpressure are determined using configurable control registers.

In one aspect, the solution offers QoS guarantees for all commands in a cache contention scenario at the expense of overall performance. The backpressure controls the amount of contention that is allowed which indirectly dictates the amount of time that each command will spend in the controller waiting to allocate a cache slot. In a malicious workload scenario where all transactions target the same cache slot, the overall performance may degrade slightly because of the backpressure, however the backpressure will apply until the contention is fully resolved and will guarantee forward progress within a bounded amount of time (drain time). This solution prevents commands from remaining starved indefinitely and eliminates the probably of triggering fatal failures when severe contention occurs on the cache resources. Additionally, this solution guarantees a tighter distribution for the access latencies and eliminates the outliers with extremely high latency values (non-failing high latencies).

The starvation mitigation relies on the ability to detect when commands are starved for cache resources. The detection triggers a filtering logic that will backpressure incoming host commands to reduce the cache resource contention. The filtering logic will maintain the backpressure on incoming host commands until the tracking logic indicates that the cache resource contention has resolved.

As described herein, reference to memory devices can apply to different memory types. Memory devices may refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes dynamic random access memory (DRAM), or some variant such as synchronous DRAM (SDRAM). A memory subsystem as described herein may be compatible with a number of memory technologies or standards, such as DDR3 (double data rate version 3, JESD79-3, originally published by JEDEC (Joint Electronic Device Engineering Council) on Jun. 27, 2007), DDR4 (DDR version 4, JESD79-4, originally published in September 2012 by JEDEC), LPDDR3 (low power DDR version 3, JESD209-3B, originally published in August 2013 by JEDEC), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235, originally published by JEDEC in October 2013), LPDDR5 (originally published by JEDEC in February 2019), HBM2 ((HBM version 2), originally published by JEDEC in December 2018), DDR5 (DDR version 5, originally published by JEDEC in July 2020), DDR6 (currently under proposal) or others or combinations of memory technologies, and technologies based on derivatives or extensions of such specifications.

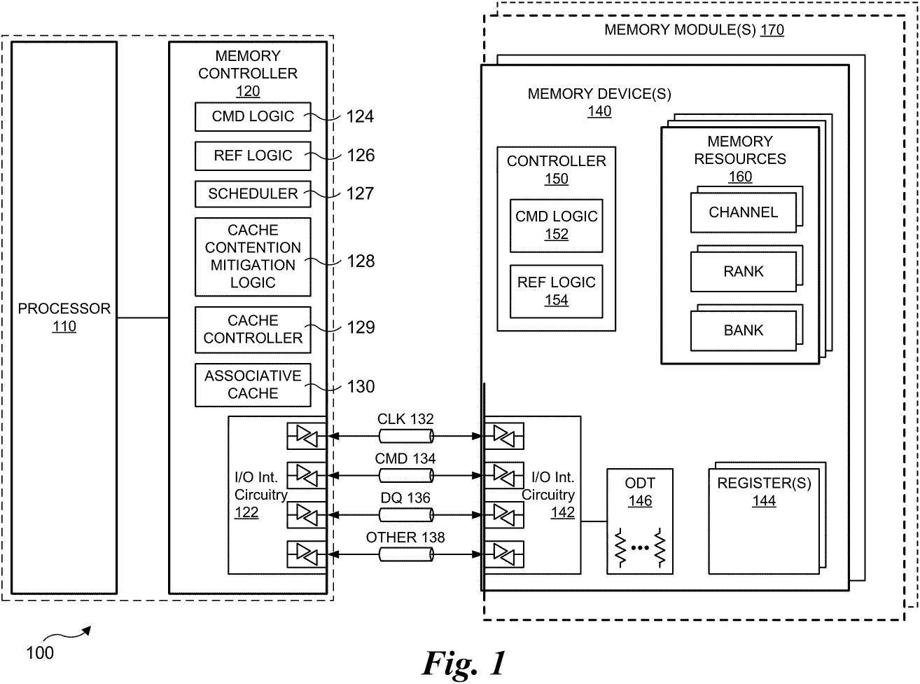

FIG. 1 illustrates an example system 100. In some examples, as shown in FIG. 1, system 100 includes a processor and elements of a memory subsystem in a computing device. Processor 110 represents a processing unit of a computing platform that may execute an operating system (OS) and applications, which can collectively be referred to as the host or the user of the memory subsystem. The OS and applications execute operations that result in memory accesses. Processor 110 can include one or more separate processors. Each separate processor may include a single processing unit, a multicore processing unit, or a combination. The processing unit may be a primary processor such as a central processing unit (CPU), a peripheral processor such as a graphics processing unit (GPU), or a combination. The processing unit may also be an “Other Processing Unit” (XPU), as discussed below. Memory accesses may also be initiated by devices such as a network controller or storage medium controller. Such devices may be integrated with the processor in some systems or attached to the processer via a bus (e.g., a PCI express bus), or a combination. System 100 may be implemented as a System on a Chip (SoC) or may be implemented with standalone components.

Reference to memory devices may apply to different memory types. Memory devices often refers to volatile memory technologies such as DRAM. In addition to, or alternatively to, volatile memory, in some examples, reference to memory devices can refer to a nonvolatile memory device whose state is determinate even if power is interrupted to the device. In one example, the nonvolatile memory device is a block addressable memory device, such as NAND or NOR technologies. A memory device may also include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

Descriptions herein referring to a “RAM” or “RAM device” can apply to any memory device that allows random access, whether volatile or nonvolatile. Descriptions referring to a “DRAM”, “SDRAM”, “DRAM device” or “SDRAM device” may refer to a volatile random access memory device. The memory device, SDRAM or DRAM may refer to the die itself, to a packaged memory product that includes one or more dies, or both. In some examples, a system with volatile memory that needs to be refreshed may also include at least some nonvolatile memory.

Memory controller 120, as shown in FIG. 1, may represent one or more memory controller circuits or devices for system 100. Also, memory controller 120 may include logic and/or features that generate memory access commands in response to the execution of operations by processor 110. In some examples, memory controller 120 may access one or more memory device(s) 140. For these examples, memory device(s) 140 may be SDRAM devices in accordance with any referred to above. Memory device(s) 140 may be organized and managed through different channels, where these channels may couple in parallel to multiple memory devices via buses and signal lines. Each channel may be independently operable. Thus, separate channels may be independently accessed and controlled, and the timing, data transfer, command and address exchanges, and other operations may be separate for each channel. Coupling may refer to an electrical coupling, communicative coupling, physical coupling, or a combination of these. Physical coupling may include direct contact. Electrical coupling, for example, includes an interface or interconnection that allows electrical flow between components, or allows signaling between components, or both. Communicative coupling, for example, includes connections, including wired or wireless, that enable components to exchange data.

According to some examples, settings for each channel are controlled by separate mode registers or other register settings. For these examples, memory controller 120 may manage a separate memory channel, although system 100 may be configured to have multiple channels managed by a single memory controller, or to have multiple memory controllers on a single channel. In one example, memory controller 120 is part of processor 110, such as logic and/or features of memory controller 120 are implemented on the same die or implemented in the same package space as processor 110.

Memory controller 120 includes one or more sets (one of which is shown) of I/O interface circuitry 122 to couple to a memory bus, such as a memory channel as referred to above. I/O interface circuitry 122 (as well as I/O interface circuitry 142 of memory device(s) 140) may include pins, pads, connectors, signal lines, traces, or wires, or other hardware to connect the devices, or a combination of these. I/O interface circuitry 122 may include a hardware interface. As shown in FIG. 1, I/O interface circuitry 122 includes at least drivers/transceivers for signal lines. Commonly, wires within an integrated circuit interface couple with a pad, pin, or connector to interface signal lines or traces or other wires between devices. I/O interface circuitry 122 can include drivers, receivers, transceivers, or termination, or other circuitry or combinations of circuitry to exchange signals on the signal lines between memory controller 120 and memory device(s) 140. The exchange of signals includes at least one of transmit or receive. While shown as coupling I/O interface circuitry 122 from memory controller 120 to I/O interface circuitry 142 of memory device(s) 140, it will be understood that in an implementation of system 100 where groups of memory device(s) 140 are accessed in parallel, multiple memory devices can include I/O interface circuitry to the same interface of memory controller 120. In an implementation of system 100 including one or more memory module(s) 170, I/O interface circuitry 142 may include interface hardware of memory module(s) 170 in addition to interface hardware for memory device(s) 140. Other memory controllers 120 may include multiple, separate interfaces to one or more memory devices of memory device(s) 140.

In some examples, memory controller 120 may be coupled with memory device(s) 140 via multiple signal lines. The multiple signal lines may include at least a clock (CLK) 132, a command/address (CMD) 134, and write data (DQ) and read data (DQ) 136, and zero or more other signal lines 138. According to some examples, a composition of signal lines coupling memory controller 120 to memory device(s) 140 may be referred to collectively as a memory bus. The signal lines for CMD 134 may be referred to as a “command bus”, a “C/A bus” or an ADD/CMD bus, or some other designation indicating the transfer of commands. The signal lines for DQ 136 may be referred to as a “data bus”.

According to some examples, independent channels may have different clock signals, command buses, data buses, and other signal lines. For these examples, system 100 may be considered to have multiple “buses,” in the sense that an independent interface path may be considered a separate bus. It will be understood that in addition to the signal lines shown in FIG. 1, a bus may also include at least one of strobe signaling lines, alert lines, auxiliary lines, or other signal lines, or a combination of these additional signal lines. It will also be understood that serial bus technologies can be used for transmitting signals between memory controller 120 and memory device(s) 140. An example of a serial bus technology is 8B10B encoding and transmission of high-speed data with embedded clock over a single differential pair of signals in each direction. In some examples, CMD 134 represents signal lines shared in parallel with multiple memory device(s) 140. In other examples, multiple memory devices share encoding command signal lines of CMD 134, and each has a separate chip select (CS_n) signal line to select individual memory device(s) 140.

In some examples, the bus between memory controller 120 and memory device(s) 140 includes a subsidiary command bus routed via signal lines included in CMD 134 and a subsidiary data bus to carry the write and read data routed via signal lines included in DQ 136. In some examples, CMD 134 and DQ 136 may separately include bidirectional lines. In other examples, DQ 136 may include unidirectional write signal lines to write data from the host to memory and unidirectional lines to read data from the memory to the host.

According to some examples, in accordance with a chosen memory technology and system design, signals lines included in other 138 may augment a memory bus or subsidiary bus. For example, strobe line signal lines for a DQS. Based on a design of system 100, or memory technology implementation, a memory bus may have more or less bandwidth per memory device included in memory device(s) 140. The memory bus may support memory devices included in memory device(s) 140 that have either a x32 interface, a x16 interface, a x8 interface, or other interface. The convention “xW,” where W is an integer that refers to an interface size or width of the interface of memory device(s) 140, which represents a number of signal lines to exchange data with memory controller 120. The interface size of these memory devices may be a controlling factor on how many memory devices may be used concurrently per channel in system 100 or coupled in parallel to the same signal lines. In some examples, high bandwidth memory devices, wide interface memory devices, or stacked memory devices, or combinations, may enable wider interfaces, such as a x128 interface, a x256 interface, a x512 interface, a x1024 interface, or other data bus interface width.

In some examples, memory device(s) 140 and memory controller 120 exchange data over a data bus via signal lines included in DQ 136 in a burst, or a sequence of consecutive data transfers. The burst corresponds to a number of transfer cycles, which is related to a bus frequency. A given transfer cycle may be a whole clock cycle for transfers occurring on a same clock or strobe signal edge (e.g., on the rising edge). In some examples, every clock cycle, referring to a cycle of the system clock, may be separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length 8 (BL8), and each memory device(s) 140 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

According to some examples, memory device(s) 140 represent memory resources for system 100. For these examples, each memory device included in memory device(s) 140 is a separate memory die. Separate memory devices may interface with multiple (e.g., 2) channels per device or die. A given memory device of memory device(s) 140 may include I/O interface circuitry 142 and may have a bandwidth determined by an interface width associated with an implementation or configuration of the given memory device (e.g., x16 or x8 or some other interface bandwidth). I/O interface circuitry 142 may enable the memory devices to interface with memory controller 120. I/O interface circuitry 142 may include a hardware interface and operate in coordination with I/O interface circuitry 122 of memory controller 120.

In some examples, multiple memory device(s) 140 may be connected in parallel to the same command and data buses (e.g., via CMD 134 and DQ 136). In other examples, multiple memory device(s) 140 may be connected in parallel to the same command bus but connected to different data buses. For example, system 100 may be configured with multiple memory device(s) 140 coupled in parallel, with each memory device responding to a command, and accessing memory resources 160 internal to each memory device. For a write operation, an individual memory device of memory device(s) 140 may write a portion of the overall data word, and for a read operation, the individual memory device may fetch a portion of the overall data word. As non-limiting examples, a specific memory device may provide or receive, respectively, 8 bits of a 128-bit data word for a read or write operation, or 8 bits or 16 bits (depending for a x8 or a x16 device) of a 256-bit data word. The remaining bits of the word may be provided or received by other memory devices in parallel.

According to some examples, memory device(s) 140 may be disposed directly on a motherboard or host system platform (e.g., a PCB (printed circuit board) on which processor 110 is disposed) of a computing device. Memory device(s) 140 may be organized into memory module(s) 170. In some examples, memory module(s) 170 may represent dual inline memory modules (DIMMs). In some examples, memory module(s) 170 may represent other organizations or configurations of multiple memory devices that share at least a portion of access or control circuitry, which can be a separate circuit, a separate device, or a separate board from the host system platform. In some examples, memory module(s) 170 may include multiple memory device(s) 140, and memory module(s) 170 may include support for multiple separate channels to the included memory device(s) 140 disposed on them.

In some examples, memory device(s) 140 may be incorporated into a same package as memory controller 120. For example, incorporated in a multi-chip-module (MCM), a package-on-package with through-silicon via (TSV), or other techniques or combinations. Similarly, in some examples, memory device(s) 140 may be incorporated into memory module(s) 170, which themselves may be incorporated into the same package as memory controller 120. It will be appreciated that for these and other examples, memory controller 120 may be part of or integrated with processor 110.

As shown in FIG. 1, in some examples, memory device(s) 140 include memory resources 160. Memory resources 160 may represent individual arrays of memory locations or storage locations for data. Memory resources 160 may be managed as rows of data, accessed via wordline (rows) and bitline (individual bits within a row) control. Memory resources 160 may be organized as separate channels, ranks, and banks of memory. Channels may refer to independent control paths to storage locations within memory device(s) 140. Ranks may refer to common locations across multiple memory devices (e.g., same row addresses within different memory devices). Banks may refer to arrays of memory locations within a given memory device of memory device(s) 140. Banks may be divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to access memory resources 160. For example, the same physical memory locations can be accessed over a specific channel as a specific bank, which can also belong to a rank. Thus, the organization of memory resources 160 may be understood in an inclusive, rather than exclusive, manner.

According to some examples, as shown in FIG. 1, memory device(s) 140 include one or more register(s) 144. Register(s) 144 may represent one or more storage devices or storage locations that provide configuration or settings for operation memory device(s) 140. In one example, register(s) 144 may provide a storage location for memory device(s) 140 to store data for access by memory controller 120 as part of a control or management operation. For example, register(s) 144 may include one or more mode registers (MRs) and/or may include one or more multipurpose registers.

In some examples, writing to or programming one or more registers of register(s) 144 may configure memory device(s) 140 to operate in different “modes”. For these examples, command information written to or programmed to the one or more register may trigger different modes within memory device(s) 140. Additionally, or in the alternative, different modes can also trigger different operations from address information or other signal lines depending on the triggered mode. Programmed settings of register(s) 144 may indicate or trigger configuration of I/O settings. For example, configuration of timing, termination, on-die termination (ODT), driver configuration, or other I/O settings.

According to some examples, memory device(s) 140 includes ODT 146 as part of the interface hardware associated with I/O interface circuitry 142. ODT 146 may provide settings for impedance to be applied to the interface to specified signal lines. For example, ODT 146 may be configured to apply impedance to signal lines included in DQ 136 or CMD 134. The ODT settings for ODT 146 may be changed based on whether a memory device of memory device(s) 140 is a selected target of an access operation or a non-target memory device. ODT settings for ODT 146 may affect timing and reflections of signaling on terminated signal lines included in, for example, CMD 134 or DQ 136. Control over ODT setting for ODT 146 can enable higher-speed operation with improved matching of applied impedance and loading. Impedance and loading may be applied to specific signal lines of I/O interface circuitry 142, 122 (e.g., CMD 134 and DQ 136) and is not necessarily applied to all signal lines.

In some examples, as shown in FIG. 1, memory device(s) 140 includes controller 150. Controller 150 may represent control logic within memory device(s) 140 to control internal operations within memory device(s) 140. For example, controller 150 decodes commands sent by memory controller 120 and generates internal operations to execute or satisfy the commands. Controller 150 may be referred to as an internal controller and is separate from memory controller 120 of the host. Controller 150 may include logic and/or features to determine what mode is selected based on programmed or default settings indicated in register(s) 144 and configure the internal execution of operations for access to memory resources 160 or other operations based on the selected mode. Controller 150 generates control signals to control the routing of bits within memory device(s) 140 to provide a proper interface for the selected mode and direct a command to the proper memory locations or addresses of memory resources 160. Controller 150 includes command (CMD) logic 152, which can decode command encoding received on command and address signal lines. Thus, CMD logic 152 can be or include a command decoder. With command logic 152, memory device can identify commands and generate internal operations to execute requested commands.

Referring again to memory controller 120, memory controller 120 includes CMD logic 124, which represents logic and/or features to generate commands to send to memory device(s) 140. The generation of the commands can refer to the command prior to scheduling, or the preparation of queued commands ready to be sent. Generally, the signaling in memory subsystems includes address information within or accompanying the command to indicate or select one or more memory locations where memory device(s) 140 should execute the command. In response to scheduling of transactions for memory device(s) 140, memory controller 120 can issue commands via I/O interface circuitry 122 to cause memory device(s) 140 to execute the commands. In some examples, controller 150 of memory device(s) 140 receives and decodes command and address information received via I/O interface circuitry 142 from memory controller 120. Based on the received command and address information, controller 150 may control the timing of operations of the logic, features and/or circuitry within memory device(s) 140 to execute the commands. Controller 150 may be arranged to operate in compliance with standards or specifications such as timing and signaling requirements for memory device(s) 140. Memory controller 120 may implement compliance with standards or specifications by access scheduling and control.

According to some examples, memory controller 120 includes scheduler 127, which represents logic and/or features to generate and order transactions to send to memory device(s) 140. From one perspective, the primary function of memory controller 120 could be said to schedule memory access and other transactions to memory device(s) 140. Such scheduling can include generating the transactions themselves to implement the requests for data by processor 110 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

In some examples, memory controller 120 includes refresh (REF) logic 126. REF logic 126 may be used for memory resources that are volatile and need to be refreshed to retain a deterministic state. REF logic 126, for example, may indicate a location for refresh, and a type of refresh to perform. REF logic 126 may trigger self-refresh within memory device(s) 140 or execute external refreshes which can be referred to as auto refresh commands by sending refresh commands, or a combination. According to some examples, system 100 supports all bank refreshes as well as per bank refreshes. All bank refreshes cause the refreshing of banks within all memory device(s) 140 coupled in parallel. Per bank refreshes cause the refreshing of a specified bank within a specified memory device of memory device(s) 140. In some examples, controller 150 within memory device(s) 140 includes a REF logic 154 to apply refresh within memory device(s) 140. REF logic 154, for example, may generate internal operations to perform refresh in accordance with an external refresh received from memory controller 120. REF logic 154 may determine if a refresh is directed to memory device(s) 140 and determine what memory resources 160 to refresh in response to the command.

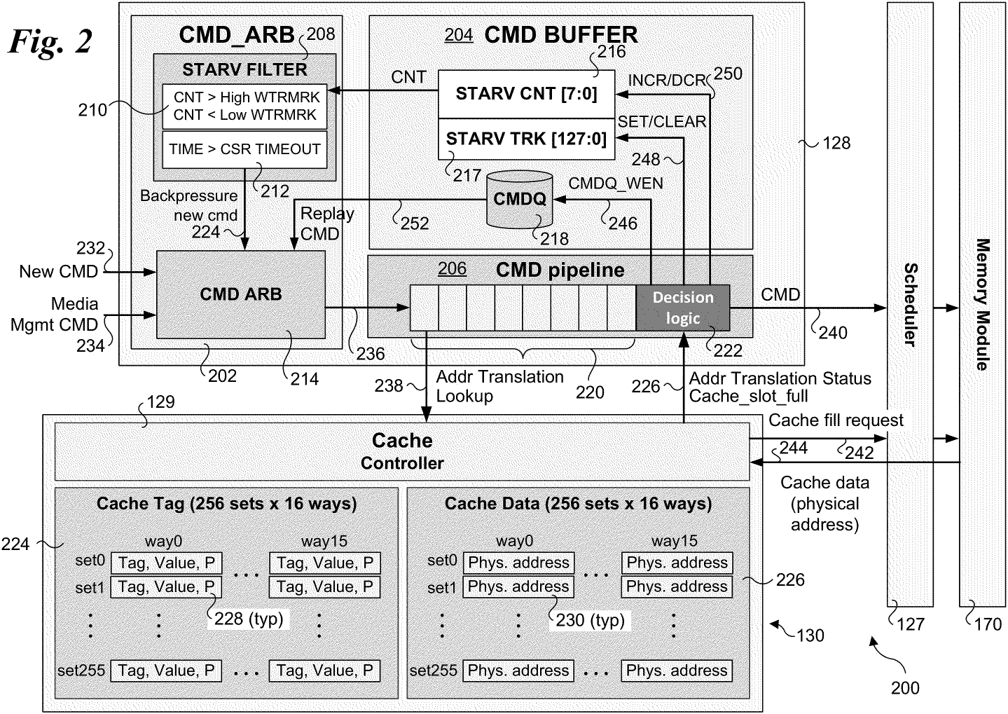

Memory controller 120 further includes cache contention mitigation logic 128, and a cache controller 129 that controls access to an associative cache 130, which are the focus of this disclosure. As shown in diagram 200 FIG. 2, cache contention mitigation logic 128 includes a command arbitration (CMD_ARB) block 202, a command buffer (CMD BUFFER) 204, and a command (CMD) pipeline 206. CMD ARB block 202 includes a starvation filter 208 having high and low watermark detection logic 210 and a CSR timeout counter 212, and provides control input to a command arbiter (CMD ARB) 214. Command buffer 204 includes a starvation counter 216, a starvation tracker 217, and a command queue (CMDQ) 218. CMD pipeline 206 includes a pipelined command stage and decision logic 222.

In the non-limiting example of FIG. 2, associated cache 130 is a set associative cache including a cache tag 224 and cache data 226, each having 256 sets × 16 ways, for a total of 4096 slots. Each slot 228 in cache tag 224 is used to store a Tag, a Value, and a (P)ending flag. Each slot 230 in cache data 226 is used to store a physical address. Slots 228 and 230 are associated on a 1:1 basis having common set and way values in both cache tag 224 and cache data 226.

One embodiment of the solution relies on three components that work together to detect, monitor, and resolve the situation:
1) Contention detection logic in cache controller 129.
2) Tracking logic in command buffer 204
3) Starvation filtering logic 208 in arbitration block 202.

### Detection

The cache controller detects when a requesting command is unable to allocate a cache resource because all the current slots for a given set are pending (a cache slot cannot be replaced if a cache fill is pending). The cache controller reports a cache miss to decision logic 222 and indicates that no cache slot was allocated because all the slots were pending. The command buffer recycles the command to command queue 218 and will replay this command at a later time.

### Tracking

In one embodiment, the tracking logic uses a tracking structure (starvation tracker 217) that is indexed by the command ID and a counter. When the command buffer receives the indication from the detection logic it marks the corresponding command index with a starved flag, and it increments the starvation counter (216). The tracking structure is used to decrement the starvation counter whenever a command that was marked with the starved flag in the tracking structure is able to make forward progress and allocate a cache slot. The starvation counter could be replaced by a function that counts the number of asserted bits in the tracking structure (the starvation counter in one implementation is used to simplify the timing convergence of this logic).

### Starvation Filter

When the starvation counter crosses a configurable high watermark (i.e., high threshold), the starvation filter triggers the backpressure mechanism. The backpressure gates the arbitration for new host commands and will only allow replayed commands and media management commands 234 to enter the pipeline. The starvation filter will maintain the backpressure on new host commands 232 until the starvation counter goes below a configurable low watermark (i.e., crosses a low threshold).

The high watermark should be set such that the controller can guarantee a certain level of QoS until the number of starved commands crosses this threshold. The low watermark shall be set to a lower value to create some hysteresis and guarantee that a high number of commands have been drained before releasing the backpressure. It is recommended to set the low watermark to 0 if performance is not a concern for malicious traffic patterns.

This mechanism creates a stop and go pattern that guarantees that the controller can flush all starved command before it absorbs the next batch of commands. This results in improved QoS for host commands in severe cache contention scenarios.

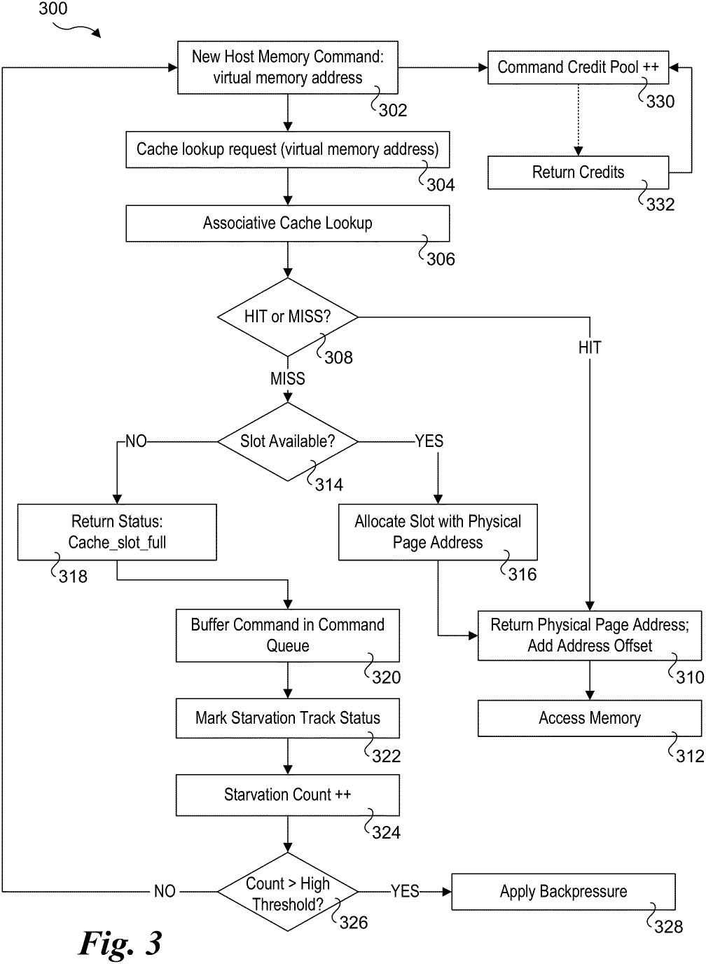

FIG. 3 shows flowchart 300 illustrating operations and logic performed by the cache contention mitigation logic, cache controller, and associative cache when operating in a normal mode without backpressure. With reference to flowchart 300 and diagram 200, the flow begins in a block 302 with a new host command 232 that includes a virtual memory address of memory to be accessed (e.g., the virtual memory address of a cache line). At this stage the command arbiter 214 is not applying backpressure and allows new memory access commands from the host to proceed to the command pipeline. Accordingly, command arbiter 214 outputs a command 236 comprising host command 232 that enters a first slot in pipelined stage 220. In a block 304, command pipeline 206 issues an address translation lookup request 238 to cache controller 129. The address translation lookup will include a virtual memory page address of the requested memory (e.g., the virtual page containing a cache line of memory). A first portion (the MSBs (most significant bits)) of the virtual memory is used to identify the virtual memory page address, while the remaining portion (the LSBs (least significant bits)), also referred to as the “offset” of the virtual memory address identifies an individual cache line within the virtual memory page.

In one embodiment, a cache tag mapping function is used that employs a hash or the like to create tag values. This is performed in conjunction with an associative cache lookup in a block 306. In one embodiment, the lower bits of the virtual page address are used to identify the set, while the upper bits are used to match the tag. If there is a matching tag in cache tag 224, the result of the lookup is a HIT, and as depicted by a decision block 308 the result of a HIT causes the logic to proceed to a block 310 in which the physical page address present in the slot 230 in cache data 226 associated with the matching tag in slot 228 is returned to decision logic 222. The address offset is then added to the physical page to form a physical memory address for a cache line and the physical memory address is forwarded by the command pipeline as a command 240 to scheduler 127, which will subsequently issue the command to memory module 170. Accessing memory using physical memory addresses utilizes conventional operations performed by memory controllers in combination with logic on (a) memory module(s), with the particular access scheme being outside the scope of this disclosure.

Returning to decision block 308, the associative cache lookup may also map to a slot that is empty or for which a pending cache fill is marked (under which the P flag for the matching tag would be marked (e.g., a ‘1’). Both cases are a MISS, which causes the logic to proceed to a decision block 314 to determine if a slot is available in the set. As depicted by a decision block 314, if a slot is available in the set the slot is allocated with the physical page address in a block 316, with the logic proceeding to block 310 to be performed in the manner described above. As shown in FIG. 2, cache controller 129 will issue a cache fill request 242 to scheduler 127. Scheduler 127 will submit the cache fill request to memory module 170, which maintains a table for mapping virtual page addresses to physical page addresses. The memory controller will use the virtual page address as a lookup for the table and return the physical page address 244 corresponding to the virtual page address to cache controller 129, which will then write the physical address to a slot 230 in cache data 226 and creating a corresponding tag entry in a slot 228 in cache tag 224. As before, at this point the physical address would be provided to decision logic 222, which would then add the address offset and issue a corresponding memory access command 240 to scheduler 127.

If there are no slots available in the set (meaning all slots in the set are marked as pending to be filled), the logic proceeds to a block 318 in which a status of “Cache_slot_ full” (message 226) is returned to decision logic 222. In blocks 320, 322, and 324 the command is buffered in command queue 218 (as depicted by arrow 246 and CMDQ_WEN (CMDQ Write enable)), a corresponding starvation track flag is marked (set) for the command (in starvation tracker 217, as depicted by arrow 248), and the starvation count (216) is incremented by 1, as depicted by an arrow 250.

In a decision block 326 a determination is made to whether the starvation count has crossed the high threshold. If it has, backpressure is applied in a block 328. If it has not, the system maintains operating without backpressure and the logic returns to block 302 to process the next host memory command.

In some embodiments, a command credit scheme is used employing a credit loop or the like. Under this scheme, when the memory controller has credits it will forward host commands to a buffer which is read by the command arbiter. When the command is read the buffer slot is cleared and a command credit value, such as a command credit pool, is incremented by 1, as depicted by a block 330. Generally, a command credit scheme will not return a credit for each host command that is read by the arbiter, but rather will return a batch of credits, as depicted by a block 332. The use of such credit schemes is known in the art and the particular scheme that is used is outside the scope of this disclosure.

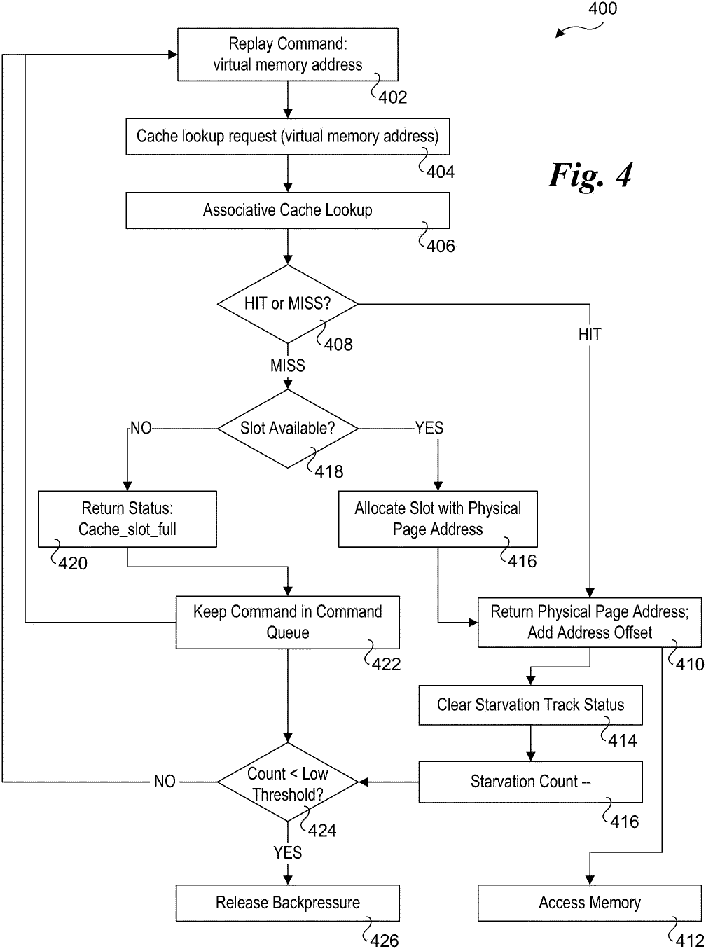

FIG. 4 shows a flowchart 400 illustrating operations and logic performed by the cache contention mitigation logic 128, cache controller 129, and associative cache 130 when backpressure is applied. As discussed above, when backpressure is being used the command arbiter will allow commands in the command queue to be replayed (as depicted by arrow 252) while blocking new host commands from entering the pipeline. Accordingly, the process begins with a replay command with a virtual memory address entering the command pipeline. Replayed commands are command for which a slot was not available and, as a result, are buffered in the command queue (as described in block 320 above). As depicted by the same text descriptions for blocks 404, 406, 410, 412, 416, 420, and decision blocks 408 and 418 in FIG. 4 and analogous blocks 304, 306, 310, 312, 316, 320, and decision blocks 308 and 318 in FIG. 3, once a replayed command has reentered the command pipeline it is handled in a similar manner as a new command with some additional operations.

As before, a cache lookup request with the virtual memory address of the replayed command is submitted to cache controller 129 (block 404) and an associative cache lookup is performed (block 406). As depicted by decision block 408, in the case of a HIT the logic proceeds to block 410 in which the physical page address is returned to which the address offset is added to obtain the physical memory address to provide to access the memory in block 412. In addition to these operations, the starvation track status for the replayed command is cleared in a block 414 and the starvation count is decremented by 1 in a block 416. In a decision block 424 a determination is made to whether the starvation count has reached the low threshold. If NO, backpressure continues to be applied with the logic returning to block 402 to replay the next command from command queue 218. If the starvation count has reached the low threshold, the answer to decision block 424 is YES and the logic proceeds to a block 426 in which the backpressure is released, returning to the normal operational mode illustrated in flowchart 300 of FIG. 3 described above.

Returning to decision block 408, if the result of the associative cache lookup is a MISS, the logic proceeds to a decision block 418 to determine whether there is an available slot for the set. If there is, the answer is YES and the logic proceeds to block 416 in which the slot is allocated with the physical page address (returned from memory module 170, in the manner described above). The logic then proceeds to perform the operations in blocks 410, 412, 414, and 416 in the manner discussed above. The low threshold determination is then reevaluated in decision block 424, with the backpressure being released in block 426 if the starvation count falls below the threshold.

If there are no slots available, a status of Cache_slot_full is returned in block 420 in a manner similar to block 320 of FIG. 3. Since the command is already in the command queue and has a current starvation track status of SET, it remains in command queue 218, as depicted in a block 422 and the logic loops back to block 402 to replay the next command from the command queue.

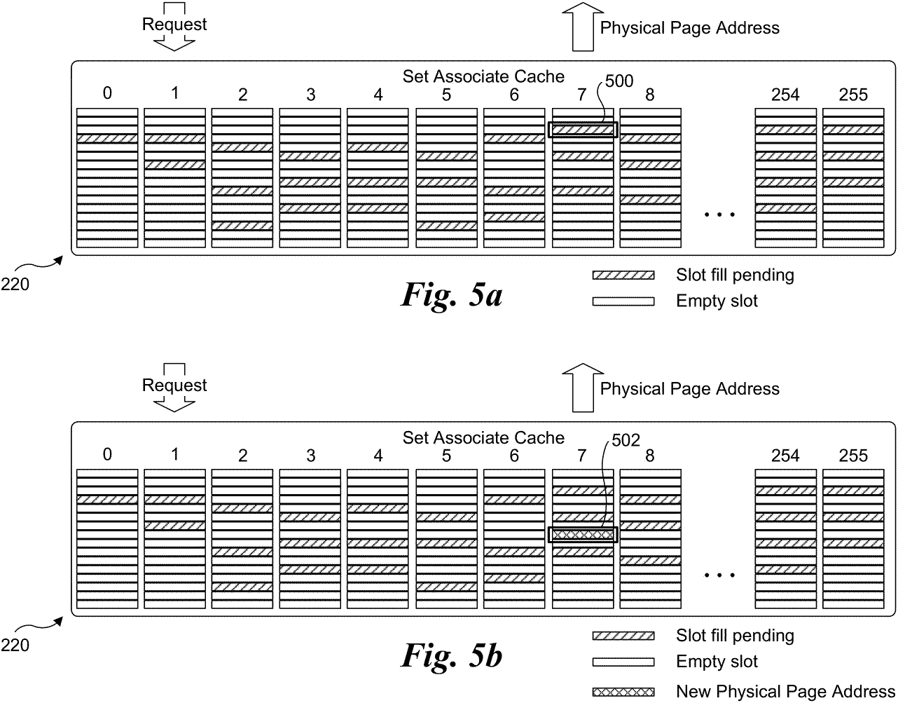

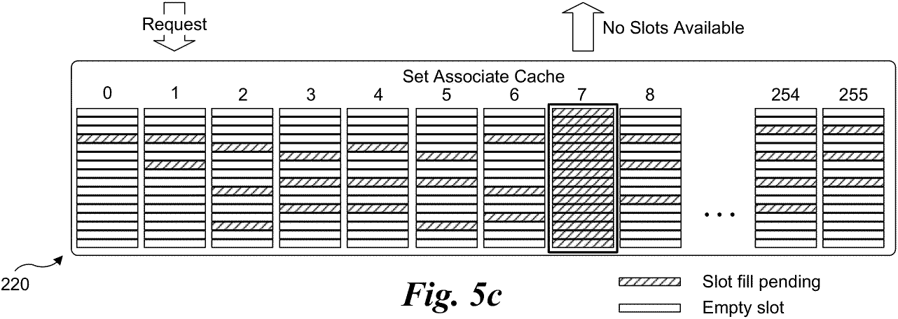

FIG. 5a shows a first state of set associative cache 130. For simplicity, in FIGS. 5a, 5b, and 5c, information corresponding to the slot fill pending and which slots contain a physical address and which slots are empty are combined into a single diagram. In this example a request for a slot is received and the lookup results in a HIT for a slot 500 in set 7. The physical page address in that slot is then returned, such as described for blocks 310 and 410 above.

FIG. 5b shows a second state of set associative cache 130. In this example the lookup results in a MISS, but there is an empty slot 502 that is available in set 7. The physical page address returned from the memory module is written to slot 502, and that physical page address is submitted to decision logic 222, such as described for blocks 316 and 416 above.

FIG. 5c shows a third state of set associative cache 130. In this example, the lookup maps to set 7, but all the slots are marked as being filled and thus no slots are available. This condition results in a status of Cache_slot_full being returned, such as described for blocks 318 and 420 above.

The solution described and illustrated herein address problems that may occur with existing approaches. For example, the existing approach does not provide any QoS guarantee for the commands that are competing for the same cache resources. The out of order nature of some memory controllers allow older commands to be replayed and make forward progress at the expense of the younger commands. One previous solution relied 248 on the repetition of the replay attempts to guarantee forward progress for all commands. However, with the increasing number of credits, it became increasingly more challenging to guarantee a certain level of QoS for all commands. As a result, certain command would remain permanently starved for cache resources and ultimately trigger system level failures. This weakness could be exploited by an attacker that gains knowledge of the cache organization (could be reverse engineered with side channel attack exploiting latency measurements). Additionally, this previous solution results in a wide and unpredictable spread on the command latencies which is not desirable from a system perspective.

In contrast, the solution described and illustrated herein provides QoS guarantees for all commands in a cache contention scenario. The backpressure controls the amount of contention that is allowed, which indirectly dictates the amount of time that each command will spend in the controller waiting to allocate a cache slot. In a malicious workload scenario where all transactions target the same cache slot, the overall performance may degrade slightly because of the backpressure, however the backpressure will apply until the contention is fully resolved and will guarantee forward progress within a bounded amount of time (drain time). This solution prevents commands from remaining starved indefinitely and eliminates the probably of triggering fatal failures when severe contention occurs on the cache resources. Additionally, this solution guarantees a tighter distribution for the access latencies and eliminates the outliers with extremely high latency values (non-failing high latencies).

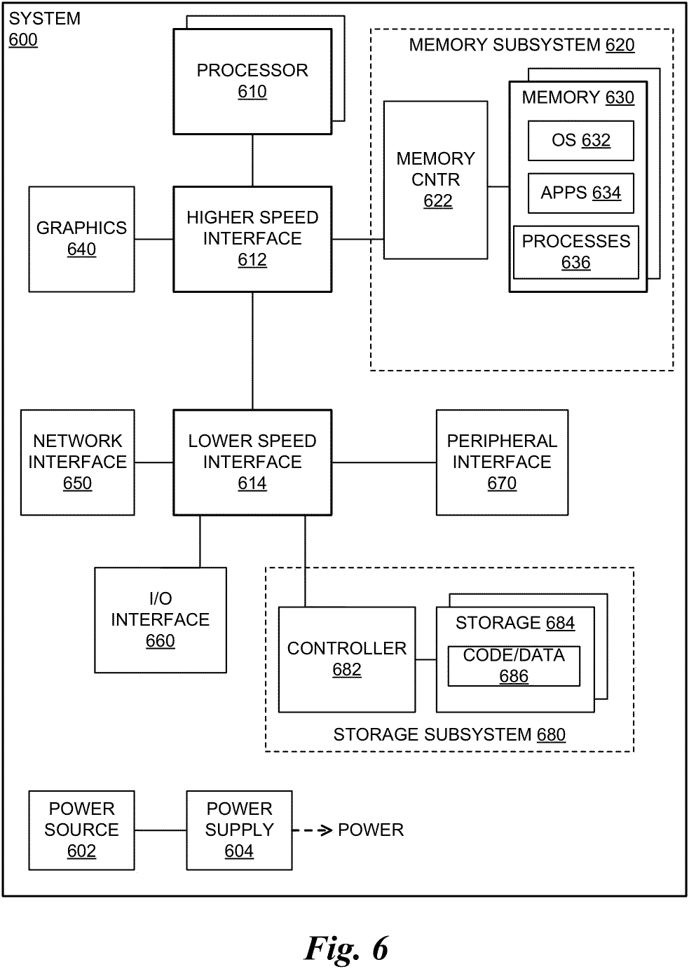

FIG. 6 illustrates an example system 600. In some examples, system 600 may be a computing system in which a memory system including a memory controller implementing aspects of the embodiments described herein may be implemented. System 600 represents a computing device in accordance with any example described herein, and can be a laptop computer, a desktop computer, a tablet computer, a server, a gaming or entertainment control system, a scanner, copier, printer, routing or switching device, embedded computing device, a smartphone, a wearable device, an internet-of-things device or other electronic device.

System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Memory subsystem 620 represents the main memory of system 600 and provides storage for code to be executed by processor 610, or data values to be used in executing a routine. Memory 630 of memory subsystem 620 may include one or more memory devices such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus.

In one example, system 600 includes interface 614, which can be coupled to interface 612. Interface 614 can be a lower speed interface than interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can exchange data with a remote device, which can include sending data stored in memory or receiving data to be stored in memory.

In one example, system 600 includes one or more I/O interface(s) 660. I/O interface(s) 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage subsystem 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage device(s) 684 holds code or instructions and data 686 in a persistent state (i.e., the value is retained despite interruption of power to system 600). Storage device(s) 684 can be generically considered to be a “memory,” although memory 630 is typically the executing or operating memory to provide instructions to processor 610. Whereas storage device(s) 684 is nonvolatile, memory 630 can include volatile memory (i.e., the value or state of the data is indeterminate if power is interrupted to system 600). In one example, storage subsystem 680 includes controller 682 to interface with storage device(s) 684. In one example controller 682 is a physical part of interface 614 or processor 610 or can include circuits or logic in both processor 610 and interface 614.

Power source 602 provides power to the components of system 600. More specifically, power source 602 typically interfaces to one or multiple power supplies 604 in system 600 to provide power to the components of system 600. In one example, power supply 604 includes an AC to DC (alternating current to direct current) adapter to plug into a wall outlet. Such AC power can be renewable energy (e.g., solar power) power source 602. In one example, power source 602 includes a DC power source, such as an external AC to DC converter. In one example, power source 602 or power supply 604 includes wireless charging hardware to charge via proximity to a charging field. In one example, power source 602 can include an internal battery or fuel cell source.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus comprising:
a memory controller having one or more channels for accessing memory, an associative cache, and logic to,
receive memory access commands for accessing the memory;
cache translated memory addresses allocated for memory access commands in the associative cache;
detect a level of cache contention for the associative cache crosses a first threshold; and,
in response thereto, limit access to the associative cache.

2. The apparatus of claim 1, wherein the associative cache comprises a set associative cache including a plurality of sets having a plurality of slots, and the level of cache contention is detected by tracking occurrences of when a cache slot is not allocated for a memory access command.

3. The apparatus of claim 2, further comprising logic to:
buffer a memory access command for which a slot is not allocated; and
subsequently replay the memory access command.

4. The apparatus of claim 3, further comprising logic to:
track memory access commands requesting access to the associative cache;
increment a count when a cache slot is unavailable to be allocated for a memory access command; and
decrement the count when a replayed memory access command is allocated a cache slot.

5. The apparatus of claim 4, wherein the count is maintained by a counter, further comprising logic to:
receive host commands to access memory from a host coupled to the apparatus or integrated in the apparatus;
detect when the count crosses the first threshold; and
in response thereto, implement a backpressure mechanism that temporarily blocks new host commands from accessing the set associative cache.

6. The apparatus of claim 5, wherein the first threshold is a high threshold, further comprising logic to:
following the count crossing the high threshold,
detect the count has crossed a low threshold; and
in response thereto, disable the backpressure mechanism.

7. The apparatus of claim 1, further comprising a command pipeline and command arbitration logic to, while the back pressure mechanism is active, block host commands from advancing to the command pipeline while enabling media management commands to advance to the command pipeline.

8. The apparatus of claim 7, wherein the command arbitration logic further is configured to allow replayed commands to reenter the command pipeline while the back pressure mechanism is active.

9. The apparatus of claim 1, wherein the apparatus comprises a processor having a System on a Chip (SoC) architecture including the memory controller.

10. A method implemented by a memory controller having an associative cache in which translated memory addresses are cached, comprising:
receiving memory access commands for accessing the memory;
cache translated memory addresses allocated for memory access commands in the associative cache;
detecting a level of cache contention crosses a first threshold; and,
in response thereto, limiting access to the associative cache.

11. The method of claim 10, wherein the associative cache comprises a set associative cache including a plurality of sets having a plurality of slots, and the level of cache contention is detected by tracking occurrences of when a cache slot is not allocated for a memory access command.

12. The method of claim 11, further comprising:
buffering a memory access command for which a slot is not allocated; and
subsequently replaying the memory access command.

13. The method of claim 12, further comprising:
tracking memory access commands requesting access to the associative cache;
incrementing a count when a cache slot is unavailable to be allocated for a memory access command; and
decrementing the count when a replayed memory access command is allocated a cache slot.

14. The method of claim 13, wherein the count is maintained by a counter, further comprising:
receiving host commands to access memory from a host;
detecting when the count crosses the first threshold; and
in response thereto, implementing a backpressure mechanism that temporarily blocks new host commands from accessing the set associative cache.

15. The method of claim 14, wherein the first threshold is a high threshold, further comprising:
following the count crossing the high threshold,
detecting the count has crossed a low threshold; and
in response thereto, disabling the backpressure mechanism.

16. The method of claim 14, further comprising:
while the back pressure mechanism is active, blocking host commands from advancing to a command pipeline while enabling media management commands to advance to the command pipeline.

17. A system, comprising:
one or more memory devices; and
a System on a Chip (SoC) including,
a plurality cores; and
a memory controller, operatively coupled to the plurality of cores and having an interface coupled to the one or more memory devices, an associative cache, and logic to,
receive memory access commands from software executing on one or more of the plurality of cores
cache translated memory addresses allocated for memory access commands in the associative cache;
detect a level of cache contention for the associative cache crosses a first threshold; and,
in response thereto, limit access to the associative cache.

18. The system of claim 17, wherein the associative cache comprises a set associative cache including a plurality of sets having a plurality of slots, and the level of cache contention is detected by tracking occurrences of when a cache slot is not allocated for a memory access command.

19. The system of claim 18, wherein the memory controller further comprises logic to: buffer a memory access command for which a slot is not allocated; and subsequently replay the memory access command.

20. The system of claim 19, wherein the memory controller further comprises logic to:
track memory access commands requesting access to the associative cache;
increment a count when a cache slot is unavailable to be allocated for a memory access command; and
decrement the count when a replayed memory access command is allocated a cache slot.
